(19) United States
(12) Patent Application Publication
(10) Pub. No.: US 2026/0130544 A1
(43) Pub. Date: May 14, 2026

(54) Multi-Surface Cooking Apparatus

(71) Applicant: Premier Specialty Brands LLC, Chamblee, GA (US)

(72) Inventors: Daniel Mercer, Hamilton, GA (US); Will Van Gelderen, Atlanta, GA (US); Klaus Xiao, Guangzhou City (CN)

(21) Appl. No.: 19/331,421

(22) Filed: Sep. 17, 2025

(30) Foreign Application Priority Data
Nov. 8, 2024 (CN) 202422729868.7

(51) Int. Cl. A47J 37/07

(52) U.S. Cl. CPC A47J 37/0704

(57) ABSTRACT

The disclosed embodiments generally comprise a cooking apparatus comprising a plurality of removal and interchangeable cooking surfaces. The cooking apparatus also comprises a burner tray positioned below the cooking surfaces and configured to facilitate grease removal, air intake, and exhaust removal for the cooking apparatus.

### CROSS-REFERENCE TO RELATED APPLICATIONS

The present application claims the benefit of priority under 35 U.S.C. § 365(a-c) and 35 U.S.C. § 119(a) to Chinese Patent Application for Utility Model No. 202422729868.7, titled “Multi-Surface Cooking Apparatus,” filed Nov. 8, 2024 with the China National Intellectual Property Administration, which is hereby incorporated by reference in its entirety as if fully set forth herein.

### TECHNICAL FIELD

The presently disclosed embodiments generally relate to cooking apparatuses, and particularly, a cooking apparatus capable of accommodating multiple types of cooking surfaces.

### BACKGROUND OF THE DISCLOSED EMBODIMENTS

Professional indoor kitchens may include a griddle, which is a generally flat cooking surface, often made of metal, and heated from below using natural gas or electricity. Cooks at a diner, for example, may use a griddle to prepare eggs, potatoes, pancakes, bacon, burgers, and so forth. Because the cooking surface is generally flat, a user may use spatulas and other utensils for combining and mixing ingredients on the griddle surface in ways that cannot easily be done when cooking using outdoor grills or even using cooking pans or pots within outdoor grills. Cleanup can be relatively easy using a griddle, as the user can use a scraper tool to push grease, liquids, and debris over an outer edge of the cooking surface for later collection and disposal.

In recent years, griddles have become popular in a residential setting. For instance, outdoor griddles have emerged that combine a griddle cooking surface affixed to a table or cart or provided as a stand-alone (e.g., tabletop) or portable unit. Outdoor griddles enable cooking enthusiasts to round out their outdoor cooking options that typically consisted of grills, smokers, and pizza ovens.

Outdoor griddles, like those found in professional indoor kitchens, typically consist of a broad, flat cooking surface composed of cast or wrought iron, aluminum, or carbon steel. Because outdoor griddles are provided as a standalone unit, they require their own heating source. Common heating sources include single or multiple flame burners and electrical elements. Additionally, cooking on a griddle produces grease and other cooking byproducts that, if not removed or cleaned, can cause build-up on or under the griddle cooking surface.

Because outdoor griddles utilize a similar heating source as indoor ovens, gas barbecue grills, and other cooking apparatuses, it is desirable that they can provide a griddle as well as other cooking options, especially when cooking multiple dishes that may require different cooking options. For instance, if a user wishes to cook stir fry on the griddle but also wishes to have a side of rice, she would have to cook her stir fry outside on the griddle and the rice inside on her stove-top or in a rice cooker. With the addition of different types of cooking surfaces, which require different needs when it comes to heating and venting, challenges arise when utilizing venting methods incorporated in existing outdoor griddles or grills.

Embodiments of the present disclosure are directed to these and other considerations.

### SUMMARY OF THE DISCLOSED EMBODIMENTS

The disclosed embodiments generally comprise a cooking apparatus (e.g. a griddle, such as one that can be used outside) capable of accommodating multiple cooking surfaces, also referred to as a multi-surface cooking apparatus. For instance, the multi-surface cooking apparatus can accommodate two or more cooking surfaces of various types, including, but not limited to, flat-top griddle surfaces, burners, cooking stones, grill grates, and/or Dutch-oven type dishes. In some embodiments, at least some of the cooking surfaces on the multi-surface cooking apparatus can be removable and interchangeable as desired by a user's cooking preferences.

To facilitate the use of multiple cooking surfaces, the multi-surface cooking apparatus incorporates a tray positioned below the cooking surfaces. In some embodiments, the tray may position and secure one or more burners used to heat the cooking surfaces. For instance, the tray may comprise a plurality of burner-receiving areas for receiving a plurality of burners and securing them in place. The burner-receiving areas may comprise a cut-out and a wall positioned around the burner for permitting air to be funneled from below the tray and to the burner during cooking.

In some embodiments, the tray may be a single unit or unitary structure that facilitates the following features for operation: (i) grease removal, (ii) air intake, and (iii) exhaust removal. Advantageously, the tray can facilitate these functions while also allowing the cooking apparatus to accommodate multiple cooking surfaces that can be interchanged as desired by a user. In some embodiments, the tray may support an area for holding solid fuel, such as wood chips, that may be combusted during cooking to provide additional smoke flavor to food items on one or more of the cooking surfaces.

The tray may be configured to facilitate grease removal from different types of cooking surfaces. For instance, adjacent cooking surfaces on the multi-surface cooking apparatus may be positioned to create a gap therebetween to allow grease and other cooking byproducts to drip over the edges of either surface and into the tray for removal. Alternatively, the cooking surfaces may comprise a grease drain, such as a hole or cut-out in the cooking surface, to allow grease to drain into the underlying tray for removal.

In some embodiments, the tray may comprise a bottom surface that is inclined to drain grease into a grease-removal area. For instance, in embodiments where a gap is formed between adjacent cooking surfaces, grease and other cooking byproducts may drip down through the gap onto the bottom surface of the tray, and due to the incline of the bottom surface, be routed downwardly to the grease-removal area.

In some embodiments, the grease-removal area may comprise a recessed channel having an inclined bottom surface that feeds grease received from the bottom surface of the tray to a grease outlet, which may be a hole or cut-out in the bottom surface of the grease-removal area. In some embodiments, the grease outlet may comprise a vertical chute for transporting grease and other cooking byproducts into a grease cup located below the tray. The grease cup may be removable to allow for easy disposal of grease.

The tray may also comprise an air-intake system and an exhaust-removal system that respectively permit air to be provided to the burners and exhaust to be removed from the cooking apparatus during cooking. In some embodiments, for instance when a lid is included over the top of the cooking surfaces, the air-intake system and exhaust-removal system may be configured to allow the cooking apparatus to have a convection-type effect that allows for even cooking on one or more of the cooking surfaces.

Burners typically require a primary air intake and a secondary air intake that each provide air to the burner to combust fuel when the burner is ignited. Embodiments of the presently disclosed invention provide an air-intake system that facilitates the use of multiple cooking surfaces on a multi-surface cooking apparatus while ensuring that each cooking surface gets the appropriate amount of heat such that the cooking surface does not get too hot or gets enough heat to cook food. In some embodiments, a tube can be positioned vertically below each burner in the multi-surface cooking apparatus, e.g., which may have one burner per cooking surface, and each tube may be coupled to the burner to deliver a primary air source and fuel (e.g. propane gas) to the burner during use. Additionally, the burner may comprise a collar or other surface that is positioned around at least a portion of the burner and comprises a plurality of air-intake holes to provide secondary air to the burner. The combination of primary air and secondary air sources to the burners in the multi-surface cooking apparatus allows the burners to ignite and remain ignited during cooking. Additionally, when the burner is positioned within a burner-receiving area of the tray, the burner-receiving area may provide a secondary flow of air from below the tray and to the burner (e.g., via collar or other surface). For instance, a wall of burner-receiving area can be positioned around the burner such that air can be drawn from below the tray and flow between the wall and the burner while not allow grease to leak down underneath the burner tray.

The tray also may permit exhaust removal through an exhaust vent. For instance, the tray may comprise a plurality of exhaust outlets positioned in or in close proximity to a back wall of the tray. When the tray is positioned in the cooking apparatus, the exhaust outlets (collectively, the exhaust vent) may facilitate exhaust removal from the burners through, for example, a hollow channel positioned between the tray and the exhaust vent.

### BRIEF DESCRIPTION OF THE DRAWINGS

The particular features and advantages of the invention will become apparent from the following description taken in connection with the accompanying drawings in which like reference numbers indicate identical or functionally similar elements. The following figures depict details of disclosed embodiments. The invention is not limited to the precise arrangement shown in these figures, as the accompanying drawings are provided merely as examples.

FIG. 1A is a perspective view of an exemplary multi-surface cooking apparatus and illustrating lines A-A′ and B-B′ through which the cross-sections in FIG. 3A and FIG. 3C respectively may be created, in accordance with certain embodiments of the present disclosure.

FIG. 1B is a front view of the exemplary multi-surface cooking apparatus of FIG. 1A, in accordance with certain embodiments of the present disclosure.

FIG. 1C is a back view of the exemplary multi-surface cooking apparatus of FIG. 1A, in accordance with certain embodiments of the present disclosure.

FIG. 1D is a perspective view of the exemplary multi-surface cooking apparatus of FIG. 1A with the cooking surfaces removed, in accordance with certain embodiments of the present disclosure.

FIG. 2A is a perspective view of an exemplary burner tray that may be used with a multi-surface cooking apparatus, such as that illustrated in FIGS. 1A-1D, and illustrating line C-C′ through which the cross-section in FIG. 2C may be created, in accordance with certain embodiments of the present disclosure.

FIG. 2B is a top view of an exemplary tray of FIG. 2A, in accordance with certain embodiments of the present disclosure.

FIG. 2C is a cross-sectional view of the tray of FIG. 2A created by passing a vertical plane through line C-C′ in FIG. 2A, in accordance with certain embodiments of the present disclosure.

FIG. 2D is a front view of the tray of FIG. 2A, and illustrating line D-D′ through which the cross-section in FIG. 2D may be created, in accordance with certain embodiments of the present disclosure.

FIG. 2E is a cross-sectional view of the tray of FIG. 2A created by passing a vertical plane through line D-D′ in FIG. 2D, in accordance with certain embodiments of the present disclosure.

FIG. 3A is a cross-section view of the multi-surface cooking apparatus illustrated in FIGS. 1A-1D created by passing a vertical plane through line A-A′ in FIG. 1A, in accordance with certain embodiments of the present disclosure.

FIG. 3B is a close-up view of the cross-section of FIG. 3A, in accordance with certain embodiments of the present disclosure.

FIG. 3C is a cross-section view of the multi-surface cooking apparatus illustrated in FIGS. 1A-1D created by passing a vertical plane through line B-B′ in FIG. 3A, in accordance with certain embodiments of the present disclosure.

FIG. 3D is a close-up view of the cross-section of FIG. 3C, in accordance with certain embodiments of the present disclosure.

FIG. 4 is a perspective view of an exemplary multi-surface cooking apparatus with a cover, in accordance with certain embodiments of the present disclosure.

### DETAILED DESCRIPTION OF THE DRAWINGS

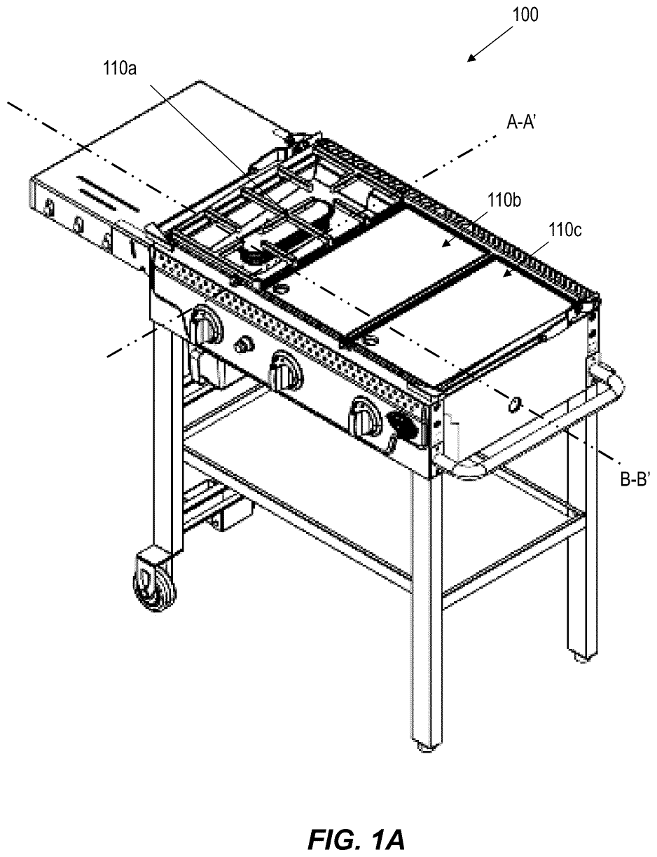

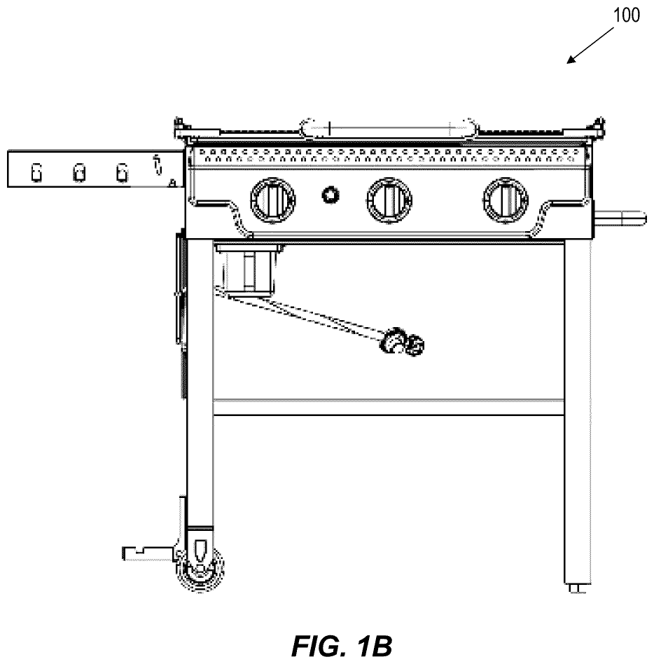

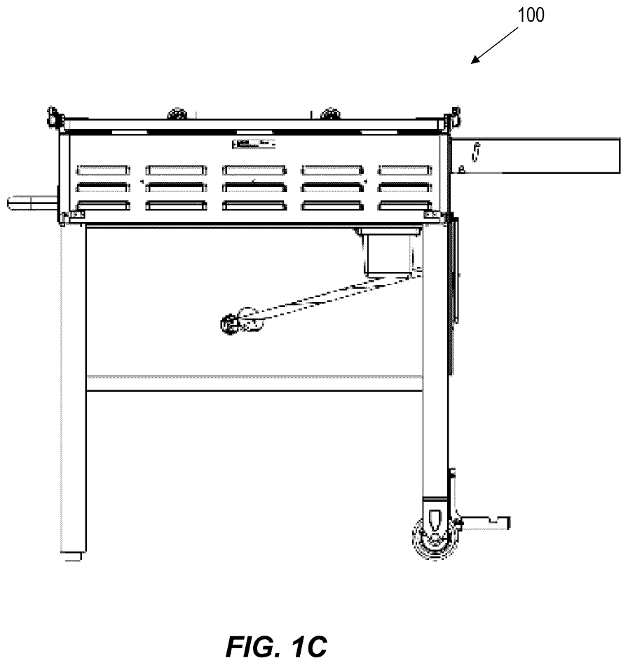

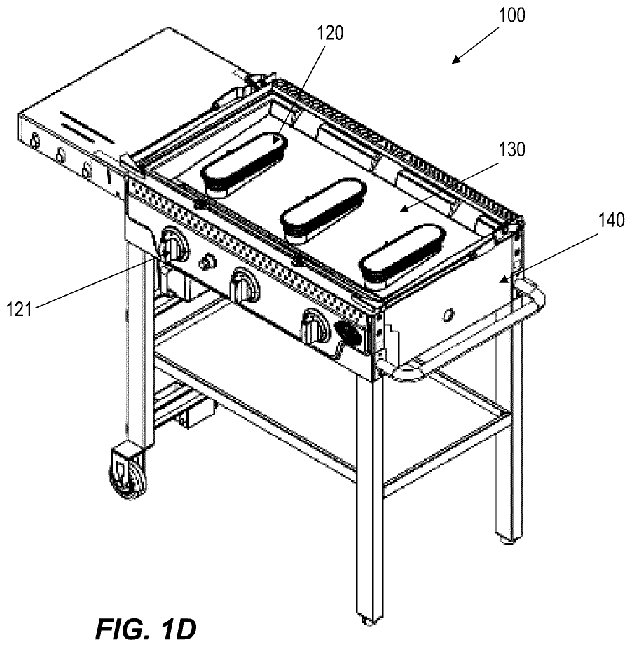

FIGS. 1A-1D illustrate an exemplary multi-surface cooking apparatus 100, in accordance with an embodiment of the present disclosure. The multi-surface cooking apparatus 100 comprises a plurality of cooking surfaces 110a-110c, that may be removable and interchangeable by a user depending on the user's cooking preferences. For instance, as illustrated in FIG. 1A, the multi-surface cooking apparatus 100 may be configured with a burner grate 110a and two griddle cooking surfaces 110b and 110c. Burner grate 110a may allow a portion of the multi-surface griddle 100 to be transformed into a burner stove-top. For example, the burner grate 110a may comprise a steel or cast iron cooking grate. Griddle cooking surfaces 110b and 110c comprise broad, flat-top surfaces similar to traditional griddle cooktops composed of, for instance, cast or wrought iron, aluminum, or carbon steel. In some embodiments, griddle cooking surfaces 110b and 110c may spaced apart such that grease can drain off the edges of the griddle cooking surfaces 110b and 110c and into an area below the cooking surfaces. In other embodiments (not shown), the multi-surface cooking apparatus 100 can be configured with various other types of cooking surfaces now known or later discovered, including grill grates, soap stones, fryer inserts, ceramic inserts, Dutch ovens, and salt stones, among others.

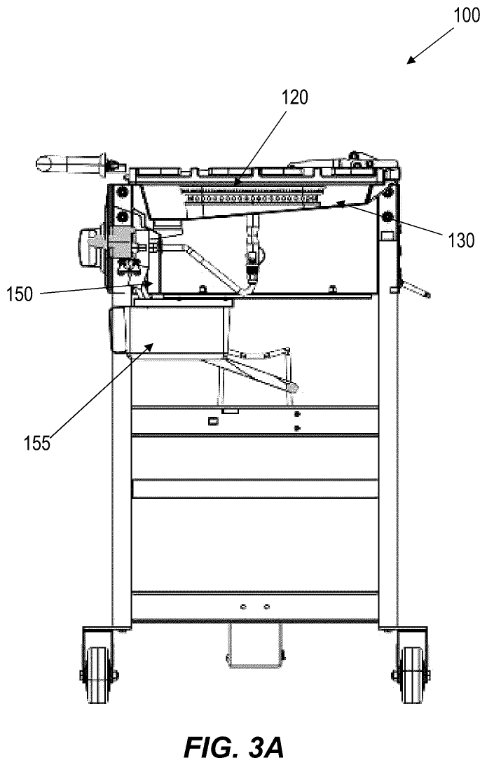

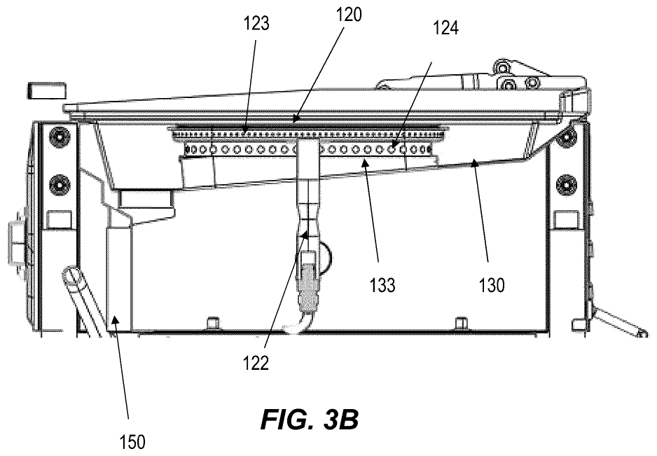

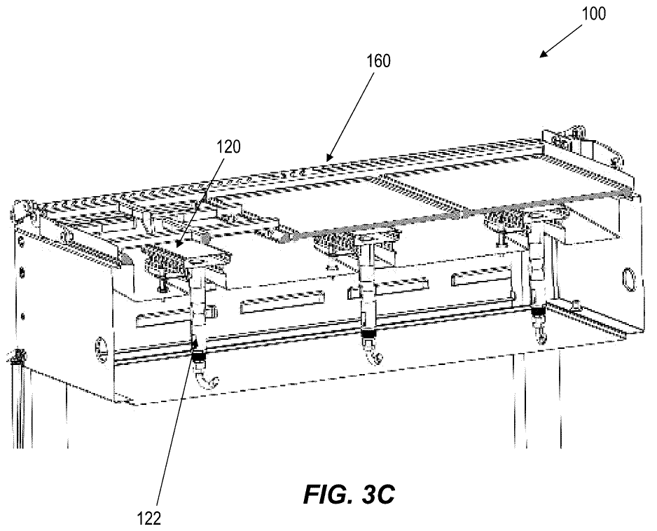

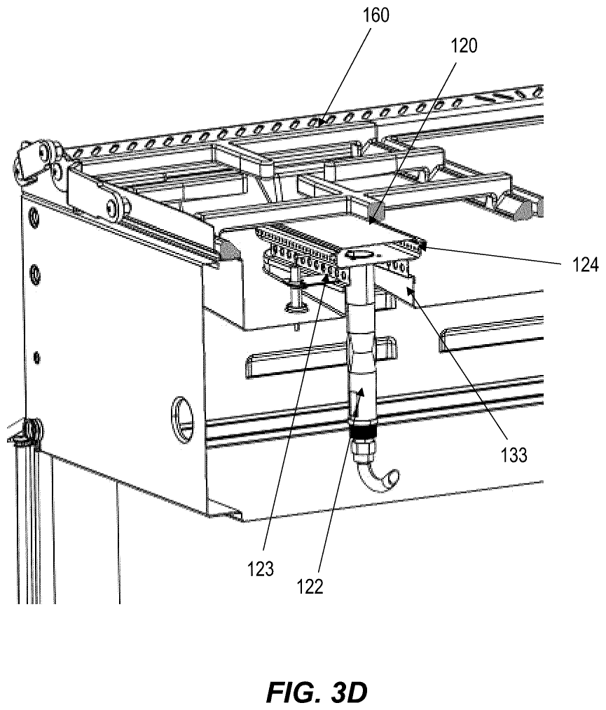

Multi-surface cooking apparatus 100 may comprise one or more heating elements for heating the cooking surfaces 110a, 110b, 110c. The heat output of the heating elements may be adjustable to be increased or decreased by a user as desired. For instance, in the example embodiment illustrated in FIG. 1D, the one or more heating elements comprise a plurality of burners 120. The burners 120 may each be coupled to a control knob 121 for adjusting the heat output of the burners 120, such as by controlling an amount of gas or electricity (e.g., voltage or current) provided to the burner. The heating elements may be coupled to a fuel or energy source, such as a propane tank or an electrical outlet. For instance, as illustrated in FIGS. 3A-3C, each of the burners 120 can be coupled to a respective tube 122 for providing propane gas to the burner.

In some embodiments, as illustrated in FIG. 1A, the multi-surface cooking apparatus 100 comprises a burner tray 130. Burner tray 130 may be held in place within a body 140 of cooking apparatus 100, such as by seating it on supports (not shown) or attaching it to one or more walls or other interior surfaces within the body 140, and the burner tray may be positioned below the cooking surfaces 110a, 110b, and 110c. The burner tray 130 may also secure one or more of the burners 120 in place.

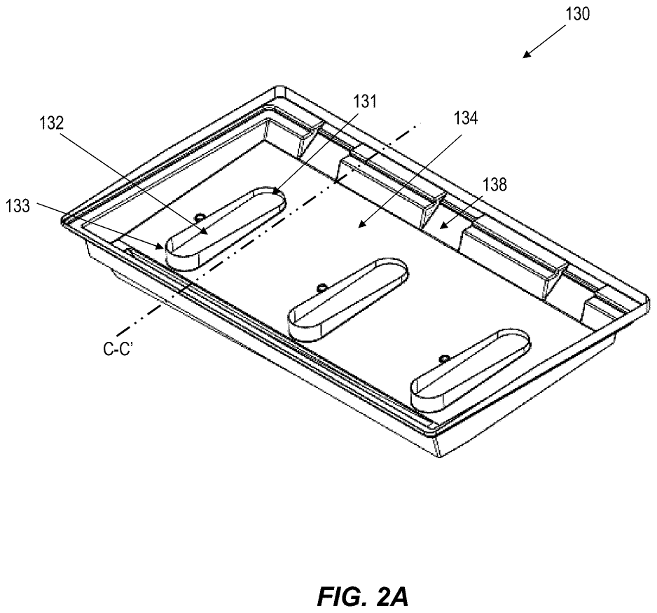

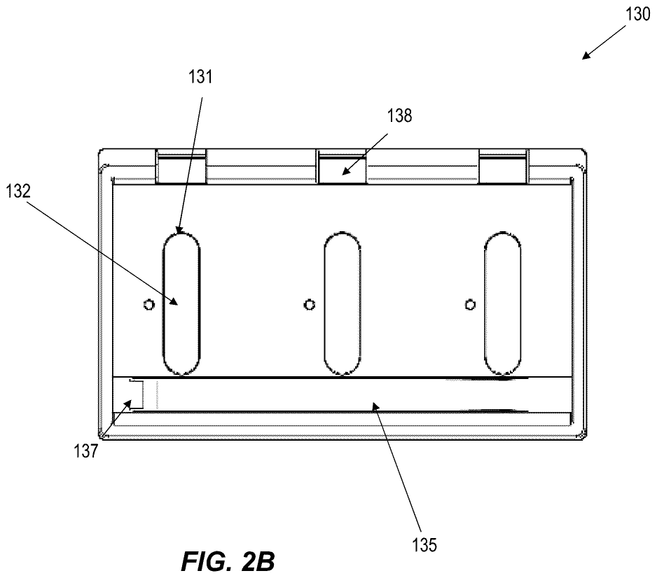

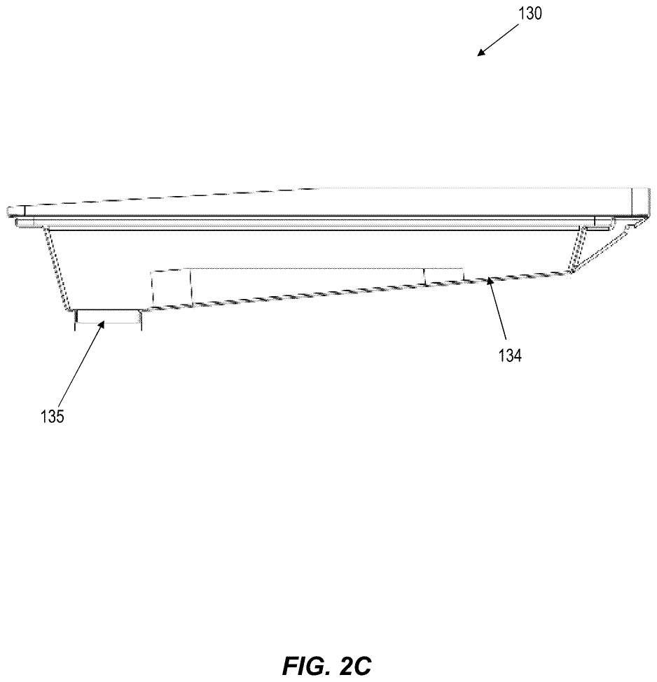

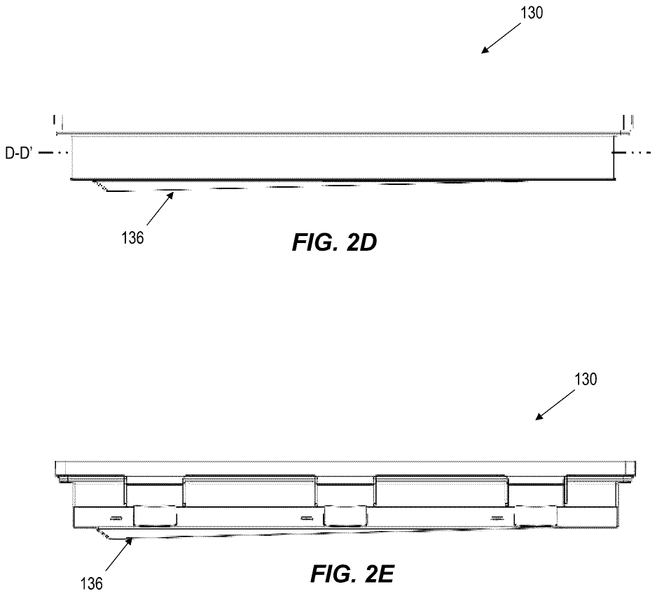

FIGS. 2A-2E illustrate an example embodiment of a burner tray 130 removed from multi-surface cooking apparatus 100 that is designed as a unitary structure. Burner tray 130 may generally comprise a receptacle for receiving grease and other cooking byproducts from the cooking surfaces 110a, 100b, and 110c. Burner tray 130 may be sized and shaped to fit within body 140 of cooking apparatus 100. For instance, as illustrated in FIGS. 2A and 2B, the burner tray 130 may be rectangular-shaped. It is understood that burner tray 130 may be any size and shape as desired to accommodate use with the multi-surface cooking apparatus in accordance with the disclosed embodiments herein.

Burner tray 130 may comprise a plurality of burner-receiving areas 131. In some embodiments, as illustrated in FIGS. 2A and 2B, burner-receiving areas 131 may generally comprise a cutout 132 that is sized and shaped to receive a burner at least partially positioned therethrough and also may comprise a wall 133 positioned above and/or around the cutout 132 for securing a burner. The cutout 132 can be approximately the same shape as a burner. Wall 133 may facilitate movement of air from below the burner tray 130 and to the burner while substantially preventing grease and other cooking byproducts from leaking below burner tray 130. It is understood that burner tray 130 may comprise the same number of burner-receiving areas 130 as there are burners, and may accommodate other heating elements as desired.

Burner tray 130 may also comprise a primary bottom surface 134 that is inclined, i.e., so that it is generally sloped toward a grease removal area 135, as illustrated for instance in FIG. 2C. In some embodiments, the primary bottom surface 134 may be inclined downwardly from a back area of the burner tray 130 to a front area of the burner tray 130 or vice versa.

In some embodiments, burner tray 130 may comprise a grease removal area 135 positioned at the bottom of inclined primary bottom surface 134. Grease removal area 135 may comprise a recessed channel having an inclined bottom surface 136 (as illustrated in FIGS. 2D and 2E) and a grease outlet 137. When grease enters the burner tray 130, it may be routed down the inclined primary bottom surface 134, into grease removal area 135, and down the inclined bottom surface 136 and into the grease outlet 137. Grease outlet 137 may be connected to a grease chute 150 which can deposit grease in a removal grease drawer 155 (both illustrated in FIG. 3A).

Burner tray 130 may also comprise one or more exhaust outlets 138 which may facilitate removal of exhaust from the burners to a vent 160, illustrated in FIGS. 1A and 3C. In some embodiments, as illustrated in FIG. 2A, exhaust outlets 138 may comprise an inclined channel within a back wall of burner tray 130 or in close proximity to the back wall of burner tray 130. The inclined channel of the exhaust outlet 138 may facilitate delivery of exhaust to an exhaust area between burner tray 130 and vent 160, shown in FIGS. 3B and 3C. The exhaust outlet 138 may comprise one or more openings through which exhaust gases may exit the cooking apparatus. The vent 160 may comprise one or more additional exhaust openings, for example, placed over the exhaust outlet 138, to provide a more aesthetic effect over the exhaust outlet.

FIGS. 3A-3D show various cross-section views of the multi-surface cooking apparatus 100 to illustrate an exemplary air-intake system for burners 120. For instance, exemplary burners 120 each may comprise a tube 122 configured to deliver a primary airflow and fuel to burner 120. Tube 122 may generally be vertically oriented and extend upwardly towards its associated burner 120.

In some embodiments, burner 120 may also comprise an air entry collar 123 comprising a plurality of holes for delivering a secondary airflow to the burner 120. As illustrated in FIG. 3D, a bottom surface of the air entry collar 123 can rest on a top edge of wall 133 of burner tray 130 to create a channel for providing secondary airflow to burner 120. For instance, the secondary airflow can be drawn from below the tray 130, between wall 133 and burner 120, to air entry collar 123, and then to burner 120. In some embodiments, burner 120 may also comprise an air exit collar 124 comprising a plurality of vent holes for removing exhaust from the burner 120 during use. The air exit collar 124 may be positioned above wall 133 of the burner tray 130. As such, during use, primary and secondary airflows can be provided to burner 120.

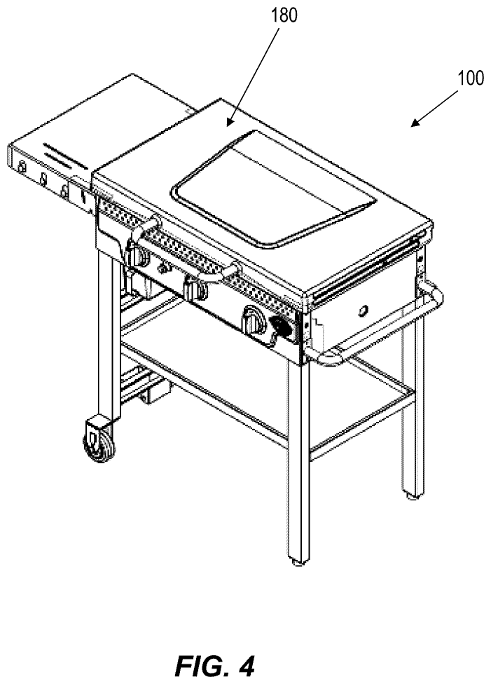

FIG. 4 illustrates the multi-surface cooking apparatus 100 further comprising a cover 180. For instance, cover 180 may be used during cooking and when coupled with the exhaust system provided by the burner tray 130, can provide a convection-type effect.

Multi-surface cooking apparatus 100 also may be configured with a secondary fuel source for imparting heat and flavor to food cooking to the cooking apparatus, such as a wood-chip unit for burning wood chips or other solid fuel during cooking.

Multi-surface cooking apparatus may comprise a cart that may be stationary or mobile to allow for the cooking apparatus to be used outside of a kitchen, for instance outside.

Those skilled in the art will also appreciate that other modifications and alternatives may be implemented in accordance with the exemplary embodiments described herein.

1. A cooking apparatus comprising:
a. at least two interchangeable and removable cooking surfaces;
b. a burner tray positioned below the at least two interchangeable and removable cooking surfaces, the burner tray configured to provide (i) grease removal; (ii) air intake; and (iii) exhaust removal.

2. The cooking apparatus of claim 1, wherein at least one of the interchangeable and removable cooking surfaces is selected from the group consisting of a flat-top griddle surface, a burner surface, a soapstone, a grill grate, a Dutch-oven type dish, and a fryer.

3. The cooking apparatus of claim 1, wherein at least two adjacent interchangeable and removable cooking surfaces are separated by a gap for removing grease from the cooking surfaces and delivering the grease to the burner tray.

4. The cooking apparatus of claim 1, wherein a primary bottom surface of the burner tray is inclined downwardly.

5. The cooking apparatus of claim 4, further comprising a grease removal area located proximate the primary bottom surface of the burner tray.

6. The cooking apparatus of claim 5, wherein the grease removal area comprises a recessed channel having an inclined bottom surface and a grease outlet.

7. The cooking apparatus of claim 6, wherein the grease outlet comprises a vertical chute configured to deliver grease to a grease cup located below the burner tray.

8. The cooking apparatus of claim 1, wherein burner tray further comprises a plurality of exhaust outlets positioned along a back wall of the burner tray.

9. The cooking apparatus of claim 8, further comprising an exhaust-removal vent positioned above the plurality of exhaust outlets.

10. The cooking apparatus of claim 9, wherein an exhaust channel is defined between the exhaust-removal vent and the plurality of exhaust outlets.

11. The cooking apparatus of claim 1, further comprising at least one burner positioned below the at least two interchangeable and removable cooking surfaces.

12. The cooking apparatus of claim 11, further comprising a tube coupled to the at least one burner and configured to deliver a primary air supply and fuel to the burner.

13. The cooking apparatus of claim 12, wherein the burner further comprises an airflow collar for delivering a secondary air supply to the burner.

14. The cooking apparatus of claim 13, wherein the burner tray comprises a burner receiving area comprising a cut-out and a wall extending above and around the cut-out.

15. The cooking apparatus of claim 14, wherein the wall is disposed below the collar for delivering the secondary air supply to the burner.

16. The cooking apparatus of claim 1, further comprising an insert for burning solid fuel.
